(19) United States
(12) Patent Application Publication
(10) Pub. No.: US 2012/0073597 A1
(43) Pub. Date: Mar. 29, 2012

(54) METHOD FOR REMOVING DEPOSITED SLUDGE

(75) Inventors: In-Hyoung RHEE, Asan-si (KR); Byung-Gi PARK, Cheonan-si (KR); Hyun-Kyoung AHN, Seoul (KR); Hyuk-Jun GWON, Seoul (KR); Chan-Ho SONG, Gumi-si (KR)

(73) Assignee: SOONCHUNHYANG UNIVERSITY INDUSTRY ACADEMY COOPERATION FOUNDATION, Asan-si (KR)

(21) Appl. No.: 13/080,092

(22) Filed: Apr. 5, 2011

(30) Foreign Application Priority Data
Sep. 28, 2010 (KR) 10-2010-0093524

(51) Int. Cl. B08B 3/10

(52) U.S. Cl. 134/1

(57) ABSTRACT

Provided is a physical and chemical cleaning method, including introducing nitrogen gas, liquid nitrogen or dry ice into a cleaning solution containing at least one selected from the group consisting of water, monoethanolamine (ETA), dimethylamine (DMA), NH₃, ethylenediaminetetraacetic acid (EDTA), diethylenetriaminepentaacetic acid (DTPA) and N₂H₂ to remove sludge. The physical and chemical cleaning method is capable of removing sludge, generated or deposited on the substrate surfaces, surfaces of constitutional parts, or gaps in various systems and instruments, more effectively. The physical and chemical cleaning method may be applied to cleaning of steam generators, boilers, heat exchangers, or the like, used in atomic power stations.

### CROSS-REFERENCE TO RELATED APPLICATIONS

This application claims priority under 35 U.S.C. §119 to Korean Patent Application No. 10-2010-0093524, filed on Sep. 28, 2010, in the Korean Intellectual Property Office, the disclosure of which is incorporated herein by reference in its entirety.

### BACKGROUND

1. Field

This disclosure relates to a physical and chemical cleaning method for deposited sludge. In particular, this disclosure relates to a physical and chemical cleaning method for sludge deposited in atomic power stations.

2. Description of the Related Art

In some systems, such as steam generators, used in atomic power stations, iron oxides or other materials contained in dousing water of atomic power stations are deposited on the surfaces to form sludge. Such deposited sludge may cause corrosion of pipes and a drop in power generation efficiency. Therefore, many processes have been suggested to remove such deposited sludge.

For example, although a chemical cleaning method generally known as the Electric Power Research Institute/Steam Generator Owner's Group (EPRI/SGOG) process provides high cleaning efficiency, it is not cost efficient and it undesirably leads to generation of a large amount of wastewater. In addition, carbon steel or low alloy steel may be corroded during the cleaning. Moreover, use of an anti-corrosive agent results in limitation in processing temperatures and in complicated treatment of wastewater.

Meanwhile, another chemical cleaning method generally known as the Advanced Scale Conditioning Agents (ASCA) chemical cleaning process adopted by Westinghouse Electric Co., Dominion Resources, Inc., or the like uses a low concentration of ethylenediaminetetraacetic acid (EDTA), amine, etc. to perform chemical cleaning. However, the ASCA process provides a relatively low cleaning efficiency. Still another chemical cleaning process adopted by Framatome ANP Co. uses the residual heat from cooling operation to heat the cleaning solution, and thus avoids a need for an external heater and reduces potential of corrosion. However, this process still provides low efficiency upon removing deposited materials present in a gap.

### SUMMARY

This disclosure is directed to solving the above-mentioned problems occurring in the related art and immediate technical problems known to those skilled in the art.

Particularly, this disclosure is directed to providing a method for removing sludge deposited on various systems and instruments more effectively.

In addition, this disclosure is directed to providing a method for removing sludge deposited on various systems and instruments used in atomic power stations, etc. more effectively.

In one aspect, there is provided a physical and chemical cleaning method, which includes soaking a subject, from which sludge is to be removed, into a cleaning solution; causing a change in temperature and pressure of the cleaning solution and forming bubble in the cleaning solution; and increasing the temperature of the subject to facilitate the removal of the sludge.

The physical and chemical cleaning method disclosed herein is capable of removing sludge, generated or deposited on the substrate surfaces, surfaces of constitutional parts, or gaps in various systems and instruments, more effectively. The physical and chemical cleaning method may be applied to cleaning of steam generators, boilers, heat exchangers, or the like, used in atomic power stations.

### BRIEF DESCRIPTION OF THE DRAWINGS

The above and other objects, features and advantages of the present invention will become apparent from the following description of certain exemplary embodiments given in conjunction with the accompanying drawing, in which:

FIG. 1 shows a schematic view of a cleaning process for a steam generator of an atomic power station using an embodiment of the physical and chemical cleaning method disclosed herein, as well as a partial enlarged view thereof.

### DETAILED DESCRIPTION OF MAIN ELEMENTS

1: C. S. (Carbon steel)
2: Cleaning solution storage tank
3: Nitrogen gas or liquid nitrogen (or dry ice) tank
4: Sludge 5: Stainless steel internal pipe
6: Injection pump 7: Relief valve
8: Solenoid valve

### DETAILED DESCRIPTION OF EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In a general aspect, there is provided a physical and chemical cleaning method for removing sludge, generated or deposited on the substrate surfaces, surfaces of constitutional parts, or gaps, for example, in steam generators, boilers and heat exchangers, and various systems and instruments of atomic power stations, the method including: introducing at least one selected from a group consisting of nitrogen gas, liquid nitrogen and dry ice into a cleaning solution to cause a change in temperature and pressure and to induce bubble formation.

According to a particular embodiment, the physical and chemical cleaning method includes introducing at least one selected from a group consisting of nitrogen gas, liquid nitrogen and dry ice into a cleaning solution containing at least one selected from the group consisting of water, monoethanolamine (ETA), dimethylamine (DMA), NH₃, ethylenediaminetetraacetic acid (EDTA), diethylenetriaminepentaacetic acid (DTPA) and N₂H₂ to remove sludge.

More particularly, the physical and chemical cleaning method includes:

soaking a part, from which sludge is to be removed, into a cleaning solution;

introducing at least one selected from a group consisting of nitrogen gas, liquid nitrogen and dry ice to the cleaning solution to cause a change in temperature and pressure and to induce bubble formation; and

warming the part to be cleaned to accelerate sludge removal.

In some instances, all of the above-described operations may be carried out, or a part of the operations may be repeated.

In the soaking operation, a part, from which sludge is to be removed, is soaked into a cleaning solution. For example, the cleaning solution may be introduced to the corresponding part and maintained at a temperature of 50-95° C. for 6-48 hours. The soaking operation is intended to allow the cleaning solution to infiltrate into the part having sludge deposited thereon.

The operation of causing a change in temperature and pressure and inducing bubble formation is intended to remove sludge from the corresponding part more effectively through a change in such parameters and bubble formation. For example, the operation may be carried out for 6-24 hours at a temperature ranging from 25 to 95° C. under a pressure ranging from 2 to 20 atm.

The operation of warming the part to be cleaned is intended to accelerate sludge removal through an increase in temperature. For example, this operation may be carried out at a temperature ranging from 25 to 95° C.

The cleaning solution used in accordance with an embodiment is based on the chemical reaction mechanism of water, dousing water of atomic power stations, DMA, etc.

As used herein, water refers to ultrapure water, which means pure water free from ions and particulate chemical species. In addition, the term ‘dousing water of atomic power stations’ means a solution containing amines, such as ETA or NH₃, and N₂H₄. In addition to the above, DMA, EDTA and DTPA may be used alone or in combination.

There is no particular limitation in the cleaning solution used for the cleaning method disclosed herein, as long as the cleaning solution effectively removes sludge. According to one embodiment, the cleaning solution may include: ETA or NH₃ in such an amount that pH of the solution is controlled to 8-10.5; and 20-250 ppb of N₂H₄. According to another embodiment, the cleaning solution may include: ETA or NH₃ in such an amount that pH of the solution is controlled to 7.5-9.5; 1 ppm-2% of EDTA, DTPA or a mixture thereof; and 20-250 ppb of N₂H₄. According to still another embodiment, the cleaning solution may include: DMA in such an amount that pH of the solution is controlled to 7.85-10.5; and 20-250 ppb of N₂H₄. When pH and temperature are controlled within the above ranges, the sludge can be removed efficiently.

According to a particular embodiment of the physical and chemical cleaning method, nitrogen gas, liquid nitrogen and/or dry ice is introduced into the cleaning solution having a boiling point of 25-95° C. or lower. Introduction of nitrogen gas, liquid nitrogen and/or dry ice into the cleaning solution causes a change in temperature and pressure, and induces bubble formation accordingly. In this manner, it is possible to remove sludge such as products by corrosion more effectively.

Hereinafter, exemplary embodiments will be described in detail with reference to the accompanying drawings.

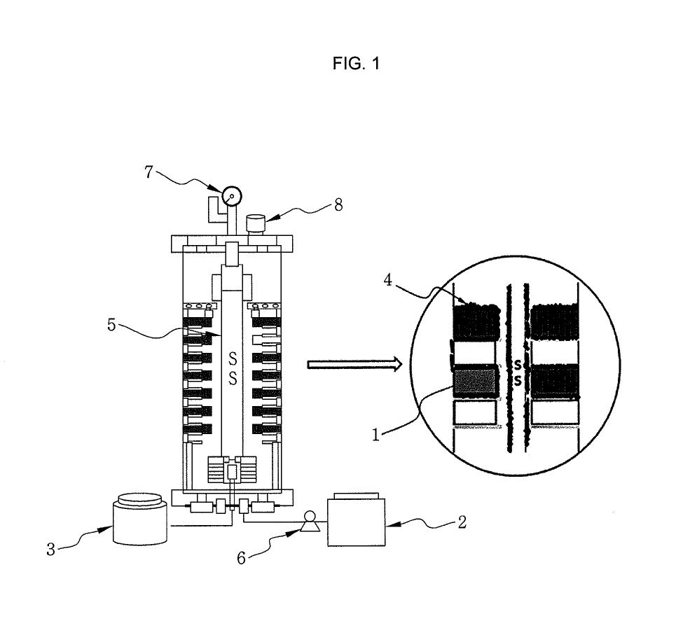

FIG. 1 shows a schematic view of a cleaning process for a steam generator of an atomic power station using an embodiment of the physical and chemical cleaning method disclosed herein. Referring to FIG. 1, the cleaning solution is supplied to the part to be cleaned from the cleaning solution storage tank 2 disposed at the bottom by way of an injection pump 6. The cleaning solution supplied to the part is obtained by adding ETA to ultrapure water to control pH to 8-10.5, and further adding N₂H₄ thereto at a concentration of 20-250 ppb.

After the part is soaked sufficiently into the cleaning solution by maintaining the temperature at 50-95° C. for 6-48 hours, nitrogen gas, liquid nitrogen (or dry ice) is supplied to the part from a nitrogen gas or liquid nitrogen (or dry ice) storage tank 3. In addition, while nitrogen gas or liquid nitrogen (or dry ice) is supplied, a relief valve 8 and a solenoid valve 7 are allowed to operate continuously or periodically. While nitrogen gas or liquid nitrogen (or dry ice) is supplied, bubbles are generated continuously or periodically, and, in particular, in the case of liquid nitrogen and dry ice, the temperature and pressure are changed within a range of 25-95° C. and 2-20 atm, respectively. The operation of causing a change in temperature and pressure and inducing bubble formation is continued for 6-24 hours. After that, water is drained.

Then, the part treated in the above manner is maintained at a temperature of 50-95° C. for 6˜48 hours. It is observed that sludge 4 may be separated from the part with ease. Finally, the part is washed with water.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. A physical and chemical cleaning method for removing sludge, comprising:
soaking a subject, from which sludge is to be removed, into a cleaning solution;
causing a change in temperature and pressure of the cleaning solution and forming bubble in the cleaning solution; and
increasing the temperature of the subject to facilitate the removal of the sludge.

2. The physical and chemical cleaning method for removing sludge according to claim 1, wherein the sludge is sludge formed in atomic power stations.

3. The physical and chemical cleaning method for removing sludge according to claim 1, wherein the cleaning solution contains at least one selected from the group consisting of water, monoethanolamine (ETA), NH₃, ethylenediaminetetraacetic acid (EDTA), diethylenetriaminepentaacetic acid (DTPA) and N₂H₂.

4. The physical and chemical cleaning method for removing sludge according to claim 1, wherein the causing a change in temperature and pressure of the cleaning solution and forming bubble in the cleaning solution is carried by introducing at least one selected from a group consisting of nitrogen gas, liquid nitrogen and dry ice to the cleaning solution to cause a change in temperature and pressure and to induce bubble formation.

5. The physical and chemical cleaning method for removing sludge according to claim 1, wherein the soaking a subject, from which sludge is to be removed, into a cleaning solution is carried out by soaking the subject to be cleaned into the cleaning solution, and then maintaining the subject at a temperature of 50-95° C. for 6-48 hours.

6. The physical and chemical cleaning method for removing sludge according to claim 1, wherein the causing a change in temperature and pressure of the cleaning solution and forming bubble in the cleaning solution is carried out for 6-24 hours, and by changing the temperature ranging from 25 to 95° C. and the pressure ranging from 2 to 20 atm.

7. The physical and chemical cleaning method for removing sludge according to claim 1, wherein the increasing the temperature of the subject to facilitate the removal of the sludge is carried out by increasing the temperature to a temperature of 50-95° C.

8. The physical and chemical cleaning method for removing sludge according to claim 1, wherein the cleaning solution comprises: ETA or NH₃ in such an amount that pH of the solution is controlled to 8-10.5; and 20 ppb-0.1% of N₂H₄.

9. The physical and chemical cleaning method for removing sludge according to claim 1, wherein the cleaning solution comprises: ETA or NH₃ in such an amount that pH of the solution is controlled to 7.5-9.5; 1 ppm-2% of EDTA, DTPA or a mixture thereof; and 20 ppb-0.1% of N₂H₄.
